(19) United States
(12) Patent Application Publication
(10) Pub. No.: US 2002/0074256 A1
(43) Pub. Date: Jun. 20, 2002

(54) Display package at least substantially made of a transparent plastic material

(76) Inventor: Wilhelmus Lucas Koeman, HH Wijdenes (NL)

Correspondence Address: Ronald A. Sandler, Jones, Day, Reavis & Pogue, 77 West Wacker Drive, Chicago, IL, 60601-1692, US

(21) Appl. No.: 09/957,577

(22) Filed: Sep. 20, 2001

(30) Foreign Application Priority Data
Sep. 21, 2000 (NL) 1016229

(51) Int. Cl. B65D 85/52; A01G 9/02

(52) U.S. Cl. 206/423; 47/84

(57) ABSTRACT

A display package at least substantially made of a transparent plastic material, with at least one cut flower packaged therein, characterized in that said display package is at least substantially made up of a hollow sleeve, in which the cut flower, stem and bulb included, is present. In particular, the sleeve includes supporting means therein, on which the bulb of the cut flower is supported in the sleeve.

### BACKGROUND OF THE INVENTION

1. Priority Claim

This application claims Convention priority of Netherlands Patent Application Number 1016229 filed Sep. 21, 2000.

2. Field of the Invention

The invention relates to a display package at least substantially made of a transparent plastic material, with at least one cut flower packaged therein.

3. Description of the Related Art

Such a display package is known from French patent publication no. 2,643,049 (Societé Civile d'Exploitation Agricole Broizat Hortirose). Said prior art transparent conical display package consists of two half shells which have been welded together along their longitudinal edges to form a watertight seal, which half shells enclose a water reservoir in the pointed end of said known display package. Said water reservoir not only functions to provide the cut flowers that are present therein with water, thus ensuring their freshness as much as possible, but also to position the cut flowers in a more or less shock-resistant manner in the known display package.

One drawback of the know display package is that the production method as described makes said display package expensive and thus economically unattractive. An additional drawback is the fact that in practice the water-tightness of the known display package, and thus the freshness of the cut flowers contained therein, is by no means guaranteed. Possible leakage has an adverse effect on the (shock-resistant) positioning of the packaged cut flowers.

### BRIEF SUMMARY OF THE INVENTION

The objection of the invention is to provide a transparent display package for cut flowers which is easy to produce and which is inexpensive, therefore, which is attractive to the public and which ensures that the cut flowers contained therein will be correctly positioned at all times, without the freshness of the cut flowers being affected.

In order to accomplish that objective, a display package of he kind referred to in the introduction is characterized in that said display package is at least substantially made up of a hollow sleeve, in which the cut flower, stem and bulb included, is present. The effect of placing the entire cut flower in the transparent sleeve in an extended position, wherein the stem and the bulb extend downwards in the sleeve, is that the cut flower will be correctly positioned in the sleeve at all times—without sagging—due to the weight of the bulb. The freshness of the cut flower is ensured for a prolonged period of time, since the flower can draw nutrition/moisture from the bulb. An important synergetic advantage is furthermore the fact that a person who buys the present sleeve can put the bulb that is present therein into the ground after some time, so that he or she will be able to enjoy a new cut flower after some time again. It will be apparent that the present sleeve can easily be produced, at very low cost, from a transparent plastic material, for example polyvinyl chloride or polyethylene.

In one preferred embodiment of a display package according to the invention, the sleeve includes supporting means therein, on which the bulb of the cut flower is supported in the sleeve. In particular, said supporting means include at least one pin extending from a bottom of the sleeve, on which the bulb can be stuck.

In another preferred embodiment of a display package according to the invention, the sleeve is round, preferably circular or elliptical, in cross-section. In another preferred variant, the sleeve is angular in cross-section. In the latter case it is preferred to use a quadrangular, hexagonal, octagonal, decagonal or dodecagonal cross-section of the sleeve. All these specific shapes give the present sleeve an aesthetic appearance, which stirs up consumer interest.

In another preferred embodiment of a display package according to the invention, the cut flower is a tulip. Although the invention relates to any bulbous plant as far as cut flowers are concerned, tulips are especially preferred. Tests have shown that a tulip having a stem and bulb is easy to position in an elegant manner in the present sleeve, whilst a tulip bulb is hardly damaged, if at all, by the aforesaid pin, for example, on which it is stuck.

In another preferred embodiment of a sleeve according to the invention, the sleeve is closed by a bottom and a cover. This makes it possible to create a closed environment in the sleeve, which resists or prevents decay/withering of the cut flower. In particular, an oxygen and/or ethylene absorbing agent, for example in the form of granules, is present in the sleeve. The effect of the absorption of oxygen and/or ethylene absorption in the sleeve is that it enhances the freshness of the cut flower present therein.

The invention furthermore relates to a method for packaging at least one cut flower in a display package which is at least substantially made of a transparent plastic material, characterized in that said cut flower, stem and bulb included, is placed into the display package, which is at least substantially in the form of a hollow sleeve.

### BRIEF DESCRIPTION OF THE SEVERAL VIEWS OF THE DRAWING

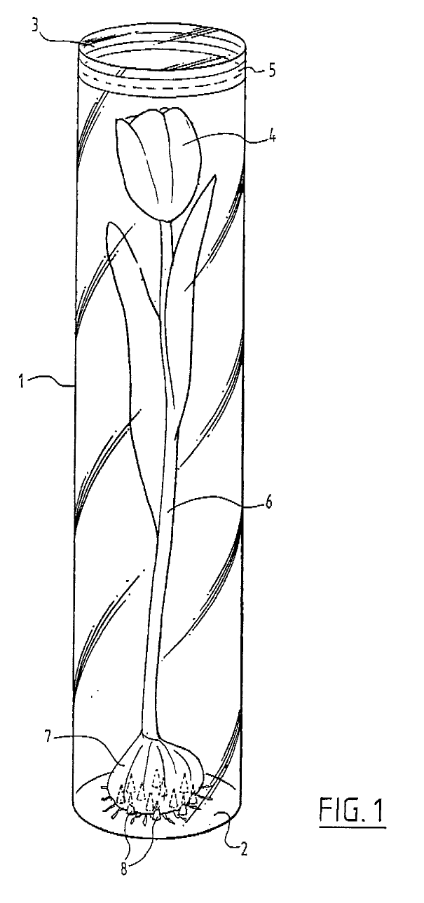

The invention will now be explained in more detail with reference to FIGS. 1-3 as shown in a drawing, which figures are schematic, perspective views of preferred variants of a sleeve according to the invention.

### DETAILED DESCRIPTION OF THE PREFERRED EMBODIMENTS OF THE INVENTION

FIG. 1 shows a sleeve of circular cross-section comprising a bottom 2 and a cover 3, with sleeve 1 and bottom 2 being integrally formed of a piece of transparent plastic material. Cover 3, which is made of the same material, has been attached to the respective end of sleeve 1 by means of adhesive tape 5 of otherwise after placement of tulip 4 into sleeve 1. Tulip 4 is placed into sleeve 1 with its stem 6 and bulb 7 extending downwards, wherein bulb 7 is stuck on pins 8 extending from bottom 2. Oxygen and/or ethylene absorbing granules may be deposited in sleeve 1 before the sleeve 1 is closed by means of cover 3, so as to create an environment low in oxygen and/or ethylene therein and thus retain the freshness of tulip 4 as much as possible.

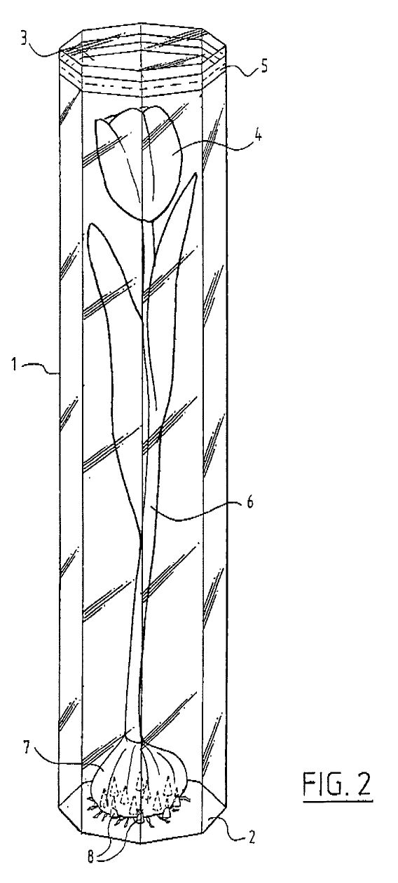

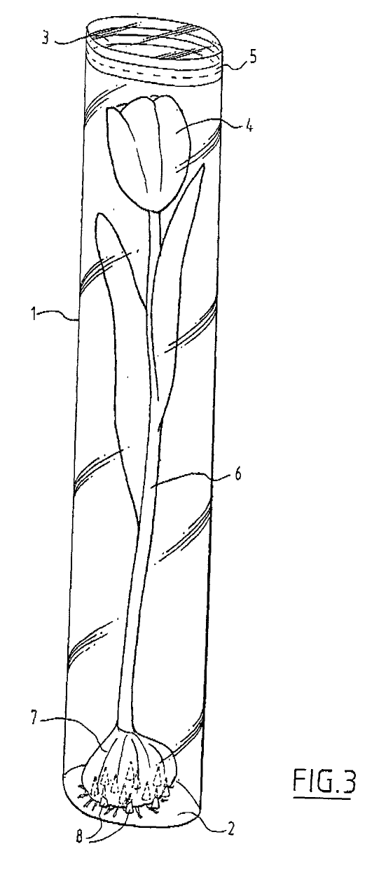

FIGS. 2 and 3 show a sleeve similar to the one that is shown in FIG. 1, with this difference that the sleeve of FIG. 2 is octagonal in cross-section and the sleeve of FIG. 3 is elliptical in cross-section, with parts corresponding to those of FIG. 1 being indicated by the same numerals.

It will be apparent that it is thus possible to place a sleeve according to FIGS. 1, 2 or 3 on a supporting surface—without using a vase—whilst it is also possible to hang such a sleeve on a wall or suspend it from a ceiling. Possibly, the bulb is packaged in the sleeve at a stage wherein the stem begins to develop, whereby the flower will develop at a later stage.

The invention is not restricted to the embodiments discussed herein, also other variants are possible, which all fall within the scope of the appended claims.

1. A display package at least substantially made of a transparent plastic material, with at least one cut flower packaged therein, characterized in that said display package is at least substantially made up of a hollow sleeve, in which the cut flower, stem and bulb included, is present.

2. A display package according to claim 1, wherein the sleeve includes supporting means therein, on which the bulb of the cut flower is supported in the sleeve.

3. A display package to claim 2, wherein said supporting means include at least one pin extending from a bottom of the sleeve.

4. A display package according to claim 2, wherein said sleeve is round in cross-section.

5. A display package according to claim 2, wherein said sleeve is angular in cross-section.

6. A display package according to claim 5, wherein said sleeve is quadrangular, hexagonal, octagonal, decagonal or dodecagonal in cross-section.

7. A display package according to any one of the preceding claim 2, wherein said cut flower is a tulip.

8. A display package according to any one of the preceding claim 2, wherein said sleeve is closed by a bottom and a cover.

9. A display package according to claim 8, wherein an an oxygen and/or ethylene absorbing agent is present in said sleeve.

10. A method for packaging at least one cut flower in a display package which is at least substantially made of a transparent plastic material, characterized in that said cut flower, stem and bulb included, is placed into the display package, which is at least substantially in the form of a hollow sleeve.
